(19) United States
(12) Patent Application Publication
(10) Pub. No.: US 2011/0037303 A1
(43) Pub. Date: Feb. 17, 2011

(54) METHOD AND SYSTEM FOR VARYING A SPEED OF A MOTOR USING A BI-DIRECTIONAL DEFLECTABLE RESISTOR

(76) Inventors: David B. Beck, Draper, UT (US); Ryan Willard, Draper, UT (US)

Correspondence Address: HOLME ROBERTS & OWEN, LLP, 299 SOUTH MAIN, SUITE 1800, SALT LAKE CITY, UT, 84111, US

(21) Appl. No.: 12/868,458

(22) Filed: Aug. 25, 2010

Related U.S. Application Data
(63) Continuation of application No. PCT/US09/35317, filed on Feb. 26, 2009.
(60) Provisional application No. 61/031,572, filed on Feb. 26, 2008.

(51) Int. Cl. B60N 2/12; H02P 7/29; B60N 2/20; B60N 2/06

(52) U.S. Cl. 297/311; 388/811; 297/354.1; 297/423.19

(57) ABSTRACT

An electronic switch for controlling a motor. The switch includes at least one deflectable resistor including a substrate having a first configuration. The substrate being bendable to a second configuration relative to the first configuration. A layer of conductive material is disposed on a surface of the substrate, wherein the layer of conductive material having a resistance that changes predictably when an electrical signal is applied thereto. The change of resistance of the layer of conductive material reflects an amount of deflection between the first configuration and the second configuration and for various configurations in between. A motor assembly is coupled to the at least one deflectable resistor. The deflectable resistor, when positioned in the first configuration turns off the motor assembly. Also, the deflectable resistor when bent towards the second configuration and away from the first configuration turns on the motor assembly. A speed of the motor assembly is controlled by the degree of bending of the at least one deflectable resistor away from the first configuration.

### CROSS REFERENCE TO RELATED APPLICATIONS

The present application claims priority to and the benefit of U.S. Provisional Application No. 61/031,572 to Beck et al., entitled “Method and System for Varying a Speed of a Motor Using a Bi-Directional Deflectable Resistor,” filed on Feb. 26, 2008, and continuation thereof which is PCT application No. PCT/US09/35317 to Beck et al., entitled “Method and System for Varying a Speed of a Motor Using a Bi-Directional Deflectable Resistor,” filed on Feb. 26, 2009, the disclosures of both of which are incorporated by reference in its entirety.

### BACKGROUND OF THE INVENTION

1. Field of the Invention

The present invention is generally directed electrical components and more particularly to electrical switches having variable control using deflectable resistors which vary in electrical resistance.

2. The Relevant Technology

Electrical switches can be used to control motors. For example, electrical switches can be used to control the position of a variety of objects. In one particular case, electrical switches are used to control the position of an automobile seat. These electrical switches typically are complicated assemblies including potentiometers coupled to a spring loaded control mechanism (e.g., joy stick) for regulating the action of the potentiometer. In the case of the automobile seat control mechanism, the one or more switches act to move the seat in various directions.

However, these electrical switches tend to be complicated, heavy, and bulky assemblies, especially when used in situations where space is at a premium. Because of these limitations, the electrical switches are limited in their functionality. Specifically, the electrical switches typically have two states: on or off. As such, when the switch is in the off state, the motor is off. Conversely, when the switch is in the on state, the motor is on. Because of the two state switch, when on, the motor runs at a constant speed.

### SUMMARY OF THE INVENTION

A system and method for an electrical switch using a bi-directional deflectable resistor for variable control of a motor. The switch includes at least one deflectable resistor including a substrate having a first configuration. The substrate being bendable to a second configuration relative to the first configuration. A layer of conductive material is disposed on a surface of the substrate, wherein the layer of conductive material is associated with a corresponding resistance that changes predictably when an electrical signal is applied thereto and is deflected to a second position. The change of resistance of the layer of conductive material reflects an amount of deflection between the first configuration and the second configuration and for various configurations in between. A motor assembly is coupled to at least one deflectable resistor. The deflectable resistor, when positioned in the first configuration turns off the motor assembly. Also, the deflectable resistor when bent towards the second configuration and away from the first configuration turns on the motor assembly. A speed of the motor assembly is controlled by the degree of bending of the deflectable resistor away from the first configuration.

### BRIEF DESCRIPTION OF THE DRAWINGS

Exemplary embodiments are illustrated in referenced figures of the drawings which illustrate what is regarded as the preferred embodiments presently contemplated. It is intended that the embodiments and figures disclosed herein are to be considered illustrative rather than limiting.

FIGS. 1-3 show an exemplary bi-directional deflectable resistor used for variable control of a motor, in accordance with embodiments of the present invention.

FIG. 4 is a diagram illustrating exploded and perspective views of an electrical switch including a bi-directional deflectable resistor for use in varying the speed of a motor, in accordance with one embodiment of the present invention.

FIG. 5 is a perspective view of an assembly used to control the position of an automobile seat, in accordance with one embodiment of the present invention.

FIG. 6 is a top view of the assembly used to control the position of an automobile seat, in accordance with one embodiment of the present invention.

FIG. 7 is a cross sectional view taken along the line B--B of the assembly in FIG. 4 used to control the position of an automobile seat, in accordance with one embodiment of the present invention.

FIG. 8 is a cross sectional view taken along the line C--C of the assembly in FIG. 4 used to control the position of an automobile seat, in accordance with one embodiment of the present invention.

FIG. 9 is a side view of the assembly in FIG. 4 used to control the position of an automobile seat, in accordance with one embodiment of the present invention.

### DETAILED DESCRIPTION OF THE PREFERRED EMBODIMENTS

Reference will now be made in detail to the preferred embodiments of the present invention, a method and system for an electrical switch using a bi-directional deflectable resistor for variable control of a motor. While the invention will be described in conjunction with the preferred embodiments, it will be understood that they are not intended to limit the invention to these embodiments. On the contrary, the invention is intended to cover alternatives, modifications and equivalents which may be included within the spirit and scope of the invention as defined by the appended claims.

Accordingly, embodiments of the present invention are capable of providing variable control over a motor thereby enabling the motor to achieve varying speeds. In addition, other embodiments of the present invention provide the above capability, and also provide for an electrical switch that is less complicated than a typical switch, less expensive to manufacture, lighter, and more robust than typical switches used for control in tight spaces.

Embodiments of the present invention are described within the context of providing an electrical switch for variable control of a motor used to position an automobile seat. However, other embodiments of the present invention are well suited to using an electrical switch for variable control of a motor for any use.

Embodiments of the present invention describe electrical switches using bi-directional deflectable resistor technology for variable control of a motor. The bi-directional deflectable resistor technology is fully described in U.S. Pat. No. 7,277,004 entitled “Bi-Directional Deflectable Resistor,” assigned to the assignee of the present application, filed on Apr. 22, 2005, which is herein incorporated by reference in its entirety.

The bi-directional deflectable resistor has a first layer of conductive material on a top surface of a substrate and a second layer of conductive material on a bottom surface of a substrate. Each layer of conductive material having a resistance that changes predictably when deflected and an electrical signal is applied thereto. The change of resistance of either the first layer of conductive material or the second layer of conductive material reflects an amount of deflection of the respective layer. Having two layers of conductive material allows for the measurement of deflection in various directions.

In general, the change of resistance of the first layer of conductive material reflects the amount of deflection between the first configuration and the second configuration. The second layer of conductive material is disposed on the bottom surface of the substrate. The second layer of conductive material has a resistance that also changes predictably when the resistor is bent from the first configuration and an electrical signal is applied thereto. The change of resistance of the second layer of conductive material reflects the amount of deflection between the first configuration and the third configuration.

In operation, the bending of the first layer of conductive material between the first configuration and the second configuration causes a number of micro-cracks that are added during the manufacturing process to open up and separate in the first layer of conductive material. As the amount of bending to the second configuration increases, the size of the micro-cracks (i.e., the distance between the conductive materials) in the first layer of conductive material increases and the resistance, therefore, also increases. Similarly, the bending of the second layer of conductive material between the first configuration and the third configuration causes a number of micro-cracks that are added during the manufacturing process to open up and separate in the second layer of conductive material. As the amount of bending to the third configuration increases, the size of the micro-cracks in the second layer of conductive material increases and the resistance, therefore, also increases.

In another embodiment, the substrate has a top surface and a bottom surface. The substrate bends in a first direction downward and away from relative to the top surface and in a second direction upward and away from relative to the bottom surface and opposite the first direction. A first layer of electrically conductive ink is disposed on the top surface of the substrate. The first layer of resistive ink has a resistance that changes predictably when the resistor bends in the first direction and an electrical signal is applied thereto. The change of resistance of the first layer of resistive ink reflects the amount of deflection in the first direction. This change in resistance is used to variably control a motor. For instance, more deflection in the first direction is associated with an increase in resistance and is used as a control to run a motor at a higher speed. Similarly, less deflection in the first direction is associated with less of an increase in resistance and is used as a control to run the motor at a lesser speed. A second layer of resistive ink is disposed on the bottom surface of the substrate.

Also, the second layer of electrically conductive ink has a resistance that changes predictably when the resistor bends in the second direction and an electrical signal is applied thereto. The change of resistance of the second layer of electrically conductive ink reflects the amount of deflection in the second direction. For instance, more deflection in the second direction is associated with an increase in resistance and is used as a control to run a motor at a higher speed. Similarly, less deflection in the second direction is associated with less of an increase in resistance and is used as a control to run the motor at a lesser speed.

The bi-directional deflectable resistor is used to control associated functions in accordance with one embodiment of the present invention. For example, the bi-directional deflectable resistor can be used to control associated movement in an automobile seat, such as moving forward and back, or moving upwards or downwards, inclining or reclining the backrest, etc. As an implementation, deflection of the bi-directional deflectable resistor in the first direction is used for controlling a first function, such as a moving the automobile seat in a forward direction. Appropriately, deflection in the second direction is used for controlling an associated second function that is different than the first, such as moving the automobile a seat in a backward direction.

Further, the bi-directional deflectable resistor is used to vary the speed of the motor controlling the first or second functions. That is, the degree of bend of the bi-directional deflectable resistor in either the first or second directions is used to control the speed of the motor effecting the first or second functions, as described previously. As such, the bi-directional deflectable resistor is used for variable control of a motor. More bend indicates more speed, and less bend indicates less speed. Of course, other embodiments allow for the opposite control mechanism, such that more bend indicates less speed, and more bend indicates more speed. Thus, the bi-directional deflectable resistor is used for variable control of a motor for the two functions, such as forward and backward movement of an automobile seat, with additional control as to the speed of the movement.

The bi-directional deflectable resistor provides for a robust circuit that can be used to provide a varying control signal depending on the resistance provided by the resistor. The configuration and function of the bi-directional resistor provides a robust circuit for providing a variable control signal. In addition, the resistor can be coated for additional protection from intruding materials that act to compromise the function of the bi-directional deflectable resistor.

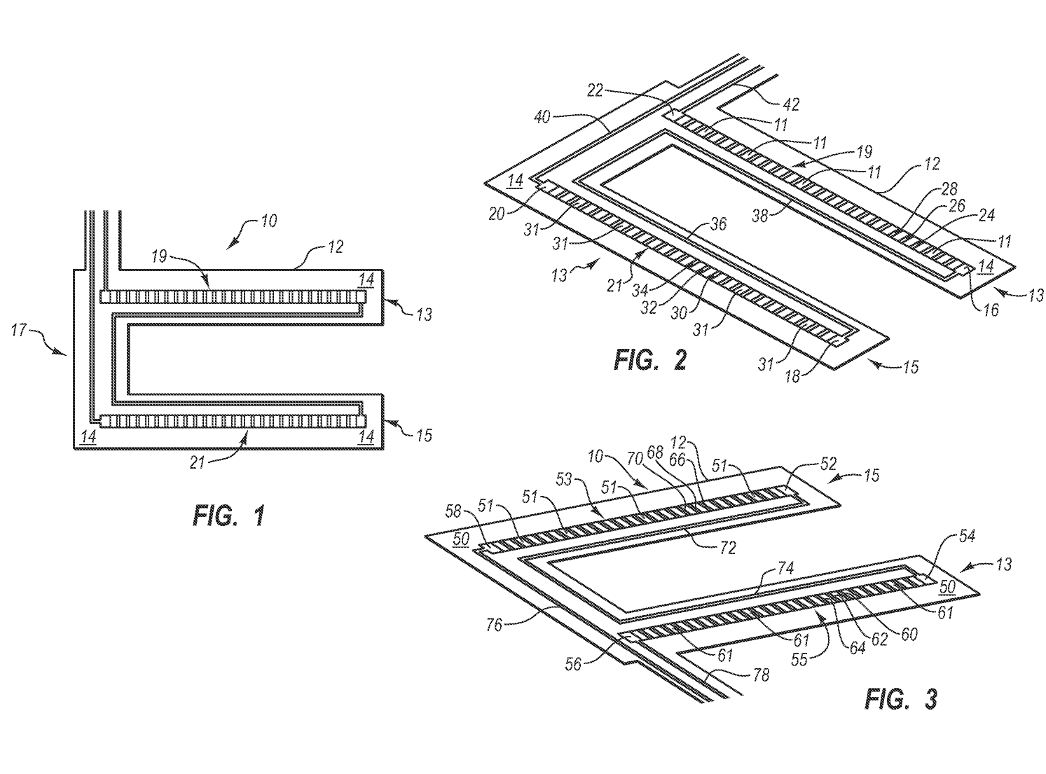

FIGS. 1-3 show an exemplary bi-directional deflectable resistor, in accordance with embodiments of the present invention. Of course, other embodiments are well suited to other configurations of the bi-directional deflectable resistor that provide a variable control signal, such as those used for variable control of a motor. FIG. 1 illustrates a top view of a bi-directional deflectable resistor 10. Bi-directional deflectable resistor 10 comprises a substrate 12 that is double sided, thereby having both a top surface 14 and a bottom surface 50 (shown in FIG. 3).

The bottom surface 50, shown in FIG. 3, is essentially a mirror image of top surface 14 and will be described in greater detail herein with respect to FIG. 3. As such, any explanation of materials, dimensions, etc. that are described with respect to the top surface 14, applies equally to bottom surface 50.

Bi-directional deflectable resistor 10 may be used to measure a degree or angle of deflection. The greater the amount of the deflection, the greater the resistance of conductible material 19, 21. With measurements, a relationship between the degree or angle of deflection of substrate 12 and the resistance of conductible material 19, 21 can be developed. In addition, the greater the resistance of conductible material 19, 21 also is used for variable control of a motor. In one embodiment, the resistance is relationally tied to the speed of a motor: more resistance indicates more speed, less resistance indicates less speed. Of course, the relationship may be reversed in other embodiments of the present invention.

In addition, a neutral position of the bi-directional deflectable resistor 10 is associated with a resistance or resistances associated with a bi-directional deflectable resistor within a range. The neutral position is associated with an off position, and indicates that the motor should be in the off position with no speed.

FIG. 2 illustrates a top perspective view of bi-directional deflectable resistor 10 in accordance with one aspect of the present invention. The top of bi-directional deflectable resistor comprises a first top layer of electrically conductive or resistive ink 11 and a second top layer of electrically conductive or resistive ink 31 disposed on the top surface 14 of substrate 12. Both the first top layer of resistive ink 11 and the second top layer of resistive ink 31 have a segmented conductor layer disposed thereon. FIG. 3 illustrates a bottom perspective view of bi-directional deflectable resistor 10 in accordance with another aspect of the present invention. As illustrated, the bottom of deflectable resistor 10 is essentially a mirror image of the top.

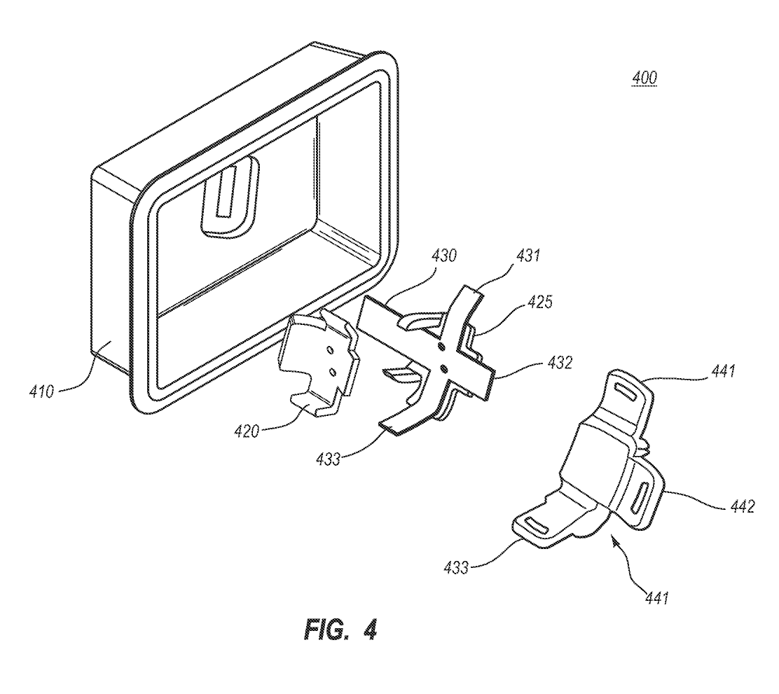

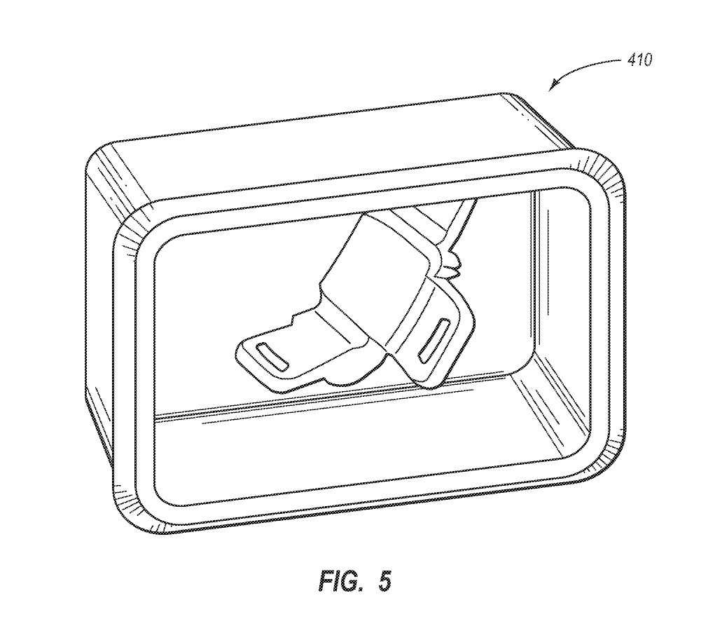

FIG. 4 illustrates exploded and perspective views of a control assembly 400 including multiple bi-directional deflectable resistors for use in varying the speed of a motor used for positioning an automobile seat, in accordance with one embodiment of the present invention. While the control assembly 400 is described in a particular configuration to enhance the interaction with a user in certain embodiments, other embodiments of the present invention are well suited to other configurations for providing variable control of a motor.

As shown in FIG. 4, the assembly 400 includes a housing 410 that encloses an electrical switch assembly. The electrical switch assembly comprises a bottom plate 425, a top plate 420, an overmold 440 and a circuit base including a conduit section 430 and multiple bi-directional deflectable resistors 431, 432, and 433.

Housing 410 is shaped such that it is capable of being recessed within the base of an automobile seat. The electrical switch assembly is held within housing 410 with open access for a user to interact with the electrical switch assembly. As such, the entire assembly 400 is recessed within the base, without any protrusions.

Top plate 420 and bottom plate 425 sandwich the circuit base. The top plate 420 and bottom plate 425 are configured such that the ends of each of the bi-directional deflectable resistors 431, 432, and 433 protrude. As such, deflection of each of the bi-directional deflectable resistors 431, 432, and 433 is possible to enable variable control of a coupled motor.

As shown, each of the bi-directional deflectable resistors control two associated functions. For instance, bi-directional deflectable resistor 431 is positioned to control the incline and recline of the backrest of the automobile seat. Similarly, bi-directional deflectable resistor 432 is positioned to control the forward and backward motion of the automobile seat. Also, bi-directional deflectable resistor 433 is positioned to control the upward and downward motion of the automobile seat.

In addition, one end of the conduit 430 enables coupling of input and output signals to each of the bi-directional deflectable resistors 431, 432, and 433. For example, power can be sent through conduit 430 to each of the bi-directional deflectable resistors 431, 432, and 433. Also, output signals from each of the bi-directional deflectable resistors 431, 432, and 433 pass through the conduit to enable variable control of a coupled motor through a control unit that is able to convert the analog signal from the electrical switch assembly to a control signal for variable control over a coupled motor. For instance, a microprocessor control unit, or transistor control unit is able to provide the proper conversion and control signal. For illustration purposes only, a microprocessor can include a pulse width modulator to vary the signal going to the motor depending on the resistance provided by a bi-directional deflectable resistor. Also, for illustration purposes only, a transistor circuit can include a transistor bias circuit that controls gain of the transistor depending on the resistance form the bi-directional deflectable resistor, in order to provide variable control of the motor.

Overmold 440 is positioned to encase the electrical switch assembly and acts as an interface between the user and the electrical switch assembly. As shown, electrical switch assembly and overmold 440 are configured to simulate the form of an automobile seat. That is, protrusion 441 corresponds to the backrest of an automobile seat, protrusion 442 corresponds to the entire seat, or alternately the base of the automobile seat, and protrusion 443 corresponds to the bottom seat of the automobile seat. A user is able to intuitively interact with overmold 440 to control positioning and movement of the automobile seat. Overmold 440 can be made of various materials, but preferably one which provides a tactile sensation that is comfortable to the user so that the user can interface with the electrical switch assembly. In addition, overmold 440 can act to bring the electrical assembly, and more specially, each of the bi-directional resistors back to a neutral position.

Dimensions of the overmold 440 are configured to simulate the form of an automobile seat, in accordance with one embodiment of the present invention. That is, the overmold is configured to roughly align with an automobile seat. For instance, each of the tabs or protrusions are configured such that when the control assembly 400 is placed within the automobile seat, a user understands that overmold 440 is controlling corresponding portions of the automobile seat. The tabs are flexible to correspond to movement of the underlying bi-directional resistors in the electrical switch assembly. Specifically, the dimensions are such that a user intuitively understands at the touch that the overmold is associated with an automobile seat. For instance, the overmold is shaped and placed within the housing 410 in such a manner that protrusion 441 intuitively is associated with the backrest of the automobile seat, protrusion 442 is intuitively associated with the entire seat, and protrusion 443 is intuitively associated with the base of the automobile seat. In that manner, the user intuitively understands that movement of protrusion 441 controls the incline and recline positioning, movement of protrusion 442 controls the forward and backward positioning, and protrusion 443 controls the upward and downward positioning of the base of the automobile seat.

Dimensions of the control assembly 400, and specifically, the electrical switch assembly are shown in FIGS. 5-9, in accordance with embodiments of the present invention. However, other dimensions of the control assembly 400 are well suited for variable control of the movement of an automobile seat, or any other object, or for variable control of a motor. For instance, each of the tabs or protrusions can range from approximately ¼ of an inch to 2 inches in length, with a similar range for the width of the tab.

In that manner, a user is able to interact intuitively with the electrical switch assembly. For instance, protrusion 441 provides an interface to the user to control the incline or recline movement and position of the automobile seat. Also, protrusion 442 provides an interface to the user to control the forward or backward movement and position of the automobile seat. Also, protrusion 443 provides an interface to the user to control the upward or downward motion and position of the automobile seat.

The bi-directional deflectable resistors 431, 432, and 433 allow for variable control of a coupled motor. For instance, moving protrusion 441 back indicates that the seat should be reclined, such as reclining a backrest of the seat. The more protrusion 441 is pushed back, the faster the automobile seat is reclined. Similarly, moving protrusion 441 forward indicates that the automobile seat should be inclined, such inclining the backrest. The more protrusion 441 is moved forward, the faster the automobile seat is inclined.

Also, moving protrusion 442 back indicates that the seat should move backward on a track. The track positions the automobile seat within a chassis of an automobile. The more protrusion 442 is moved back, the faster the automobile seat moves towards the rear of the vehicle. Similarly, moving protrusion 442 forward indicates that the automobile seat should move forward on the track. The more protrusion 442 is moved forward, the faster the automobile seat moves towards the front of the vehicle.

Also, moving protrusion 443 down indicates that the seat should move downward towards the floor of the vehicle. The more protrusion 443 is pushed down, the faster the automobile seat moves towards the floor of the vehicle. Similarly, moving protrusion 443 up indicates that the seat should move upwards towards the roof of the vehicle. The more protrusion 441 is moved up, the faster the automobile sat moves towards the roof of the vehicle.

FIG. 5 is a perspective view of the control assembly 400 that is used to control the position of an automobile seat, in accordance with one embodiment of the present invention. As configured, control assembly 400 is able to be positioned in an automobile seat such that the opening is flush with the surface of the automobile seat. The electrical switch assembly is also positioned within the automobile seat, and does not protrude unnecessarily from the seat. Of course, other embodiments of the invention allow for varying degrees of protrusion of the assembly 400, the electrical switch assembly, or a combination of both. As shown, control signals are able to access the electrical switch assembly through the rear of the control assembly 400.

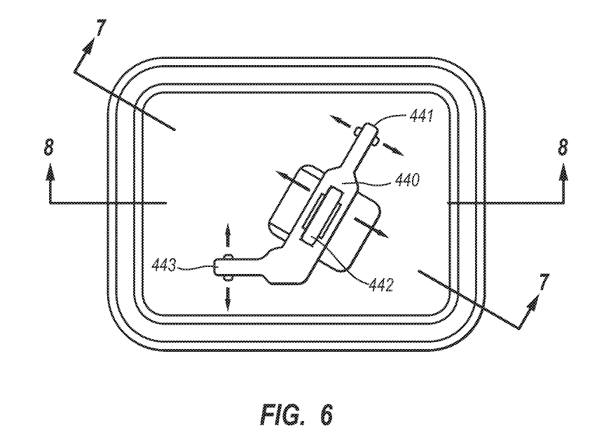

FIG. 6 is a top view of the control assembly 400 used to control the position of an automobile seat, in accordance with one embodiment of the present invention. As shown, overmold 440 is positioned within housing 410 with protrusions 441, 442, and 443 configured for interaction with a user to control movement of the automobile seat in part through the electrical switch assembly. For instance, movement of protrusion 441 in the direction of the arrows variably controls the incline and recline movement of the backrest. Movement of protrusion 442 in the direction of the arrows variably controls the forward and backward movement of the automobile seat. Also, movement of the protrusion 443 in the direction of the arrows variably controls the upward and backward movement of the automobile seat.

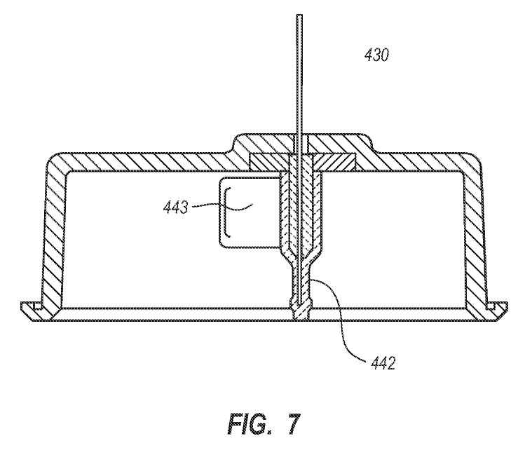

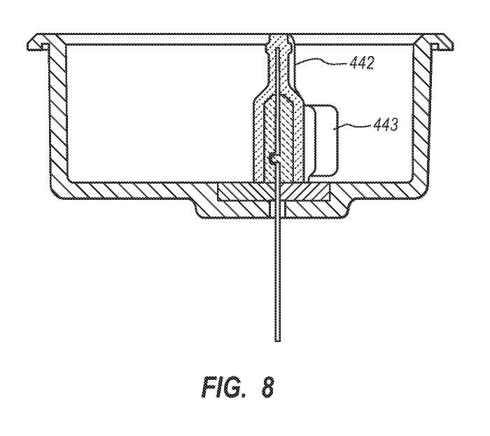

FIG. 7 is a cross-sectional view taken along the line B--B and FIG. 8 is a cross-sectional view taken along line C--C of the control assembly 400 in FIG. 4 used to variably control the position of an automobile seat, in accordance with one embodiment of the present invention. Conduit 430 is shown for enabling control signals to reach electrical switch assembly. Also, protrusion 443 is shown in FIG. 7 and is used to control the upward and downward movement of the automobile seat. In addition, protrusion 442 is shown and is used to control forward and backward movement of the automobile seat.

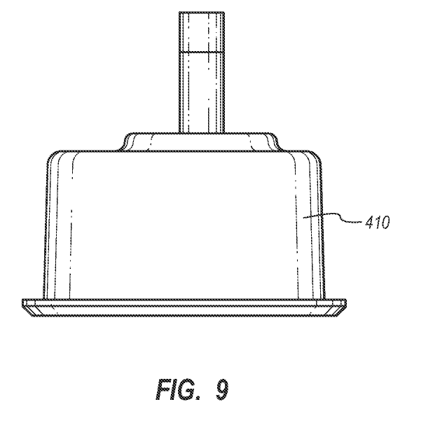

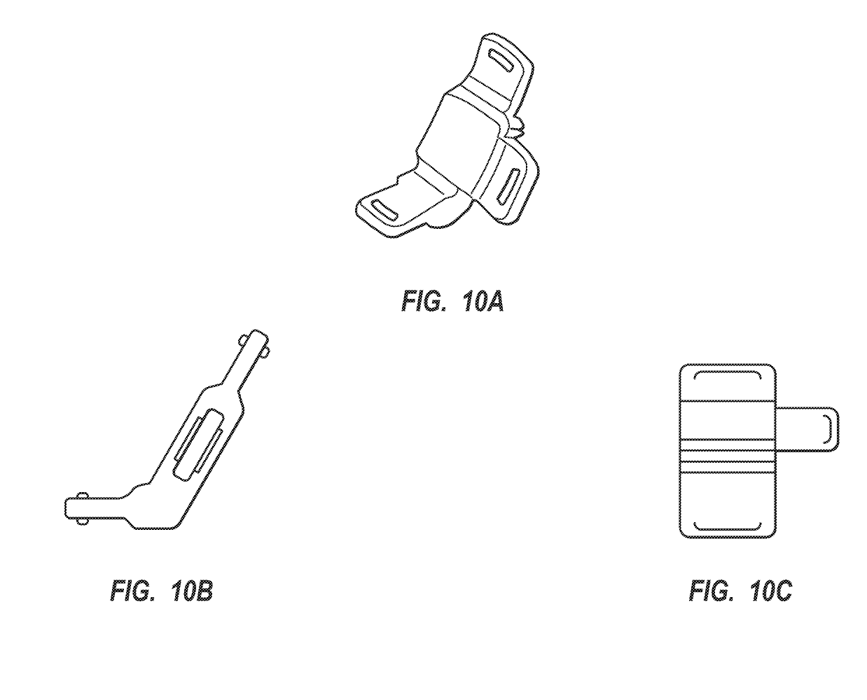

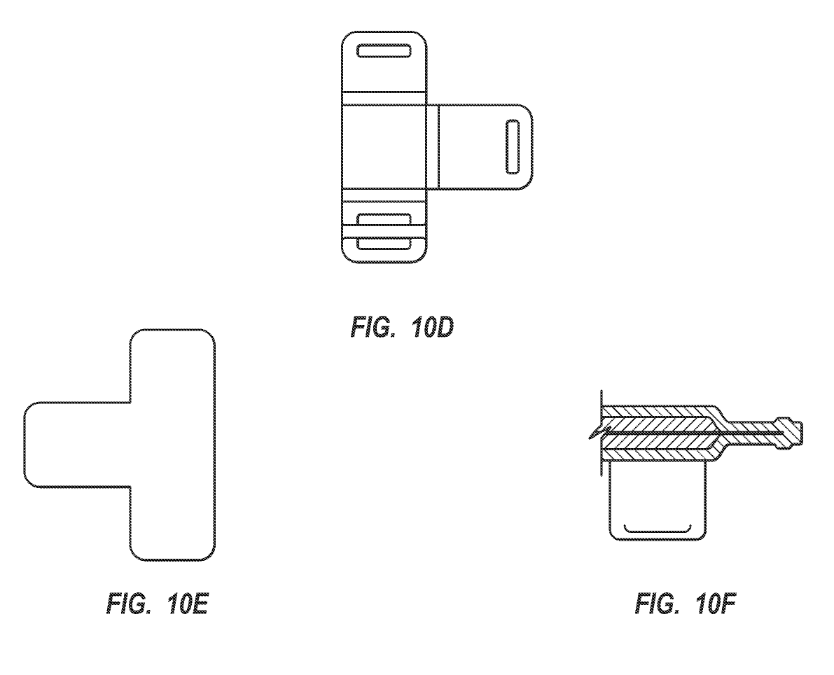

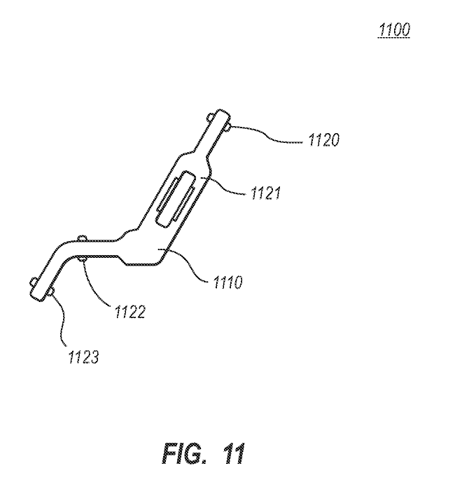

FIG. 9 is a side view of the control assembly 400 in FIG. 4 used to control the position of an automobile seat, in accordance with one embodiment of the present invention. Specifically, FIG. 9 shows a side view of housing 410. The control assembly 400 provides a light weight and robust electrical switch assembly for variable control of a motor that provides movement of an automobile seat.

FIG. 10A-F are additional views of the electronic switch assembly shown in FIGS. 4-9, in accordance with embodiments of the present invention. Specifically, FIG. 10A is a perspective view of the electronic switch assembly. FIG. 10B is a top view of the electronic switch assembly. FIG. 10C is a side view of the electronic switch assembly. FIG. 10D is a front view of the electronic switch assembly. FIG. 10E is a back view of the electronic switch assembly. FIG. 5 is another top view of the electronic switch assembly.

FIG. 11 is an illustration of an electrical switch assembly 1100 and a corresponding overmold 1110 for controlling 4 associated functions of an automobile seat, in accordance with one embodiment of the present invention. The electrical switch assembly 1100 includes tabs 1120, 1121, 1122, and 1123. The electrical switch assembly 1100 has similar functions to the assembly shown in FIGS. 4-10. For instance, tab 1120 controls the associated functions of incline and recline positioning of an automobile seat, tab 1121 controls the associated functions of forward and backward positioning of the automobile seat, and tab 1122 controls the associated functions of upward and downward positioning of the automobile seat

However, the electrical switch assembly 1100 includes an additional tab 1123 for controlling the upward radial lift of the leg rest away from the floor of the vehicle, and the downward radial lift of a leg rest of the automobile seat towards the floor of the vehicle. As such, the electrical switch assembly 1100 can be used to control one or more associated functions. As shown in FIG. 11, 4 associated functions are controlled, however, other embodiments of the present invention are well suited to controlling one pair of associated functions, two pairs of associated functions, etc.

Accordingly, embodiments of the present invention are capable of providing variable control over a motor thereby enabling the motor to achieve varying speeds. In addition, other embodiments of the present invention provide the above capability, and also provide for an electrical switch that is less complicated than a typical switch, lighter, less expensive, and more robust than typical switches used for control in tight spaces.

A system and method for an electrical switch using a bi-directional deflectable resistor for variable control of a motor. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments, but rather construed according to the below claims.

What is claimed:

1. An electronic switch for controlling a motor, comprising:
at least one deflectable resistor including a substrate having a first configuration, said substrate being bendable to a second configuration relative to said first configuration, and a layer of conductive material disposed on said surface, wherein said layer of conductive material having a resistance that changes predictably when an electrical signal is applied thereto, said change of resistance of said layer of conductive material reflects an amount of deflection between said first configuration and said second configuration and for various configurations in between; and
a motor assembly coupled to said at least one deflectable resistor, wherein said deflectable resistor when positioned in said first configuration turns off said motor assembly, and wherein said deflectable resistor when bent towards said second configuration and away from said first configuration turns on said motor assembly, and wherein a speed of said motor assembly is controlled by the degree of bending of said at least one deflectable resistor away from said first configuration.

2. The electronic switch of claim 1, further comprising:
a control unit for converting a resistance reading corresponding to said degree of bending of said at least one deflectable resistor to a control signal used to vary said speed of said motor assembly.

3. The electronic switch of claim 1, wherein said control unit comprises a pulse width modulator for generating said control signal depending on said resistance reading.

4. A system for controlling an automobile seat, comprising:
a bi-directional deflectable resistor including a substrate having a first configuration, said substrate being bendable in a first direction to a second configuration relative to said first configuration and bendable in a second direction generally opposite said first direction to a third configuration relative to said first configuration, and a first layer of conductive material disposed on a top surface of said bi-directional deflectable resistor, wherein said first layer of conductive material having a resistance that changes predictably when an electrical signal is applied thereto, said change of resistance of said first layer of conductive material reflects an amount of deflection between said first configuration and said second configuration and for various configurations in between, and wherein said second layer of conductive material having a resistance that changes predictably when an electrical signal is applied thereto, said change of resistance of said second layer of conductive material reflects an amount of deflection between said first configuration and said third configuration and for various configurations in between; a first control signal associated with said first layer of conductive material, wherein said first control signal is in an off state when said substrate is positioned in said first configuration, and in an on state when said substrate is bent towards said second configuration away from said first configuration, wherein an output of said first control signal varies by the degree of bending of said substrate away from said first configuration, and wherein said first control signal is used to control a first positioning function of an automobile seat;
a second control signal associated with said second layer of conductive material, wherein said second control signal is in an off state when said substrate is positioned in said first configuration, and is in an on state when said substrate is bent towards said third configuration away from said first configuration, wherein an output of said second control signal varies by the degree of bending of said substrate away form said first configuration, and wherein said second control signal is used to control a second positioning function of said automobile seat.

5. The system of claim 4, wherein said first positioning function comprises an inclining function used to incline a backrest of said automobile seat, and said second positioning function comprises a reclining function used to recline said backrest.

6. The system of claim 4, wherein said first positioning function comprises a forward function used to move said automobile seat forward on a track, and said second positioning function comprises a backward function used to move said automobile seat backward on said track, wherein said track positions said automobile seat within a chassis of an automobile.

7. The system of claim 4, wherein said first positioning function comprises a downward function used to move said automobile seat downward toward a floor of an automobile chassis, and said second positioning function comprises an upward function used to move said automobile seat upward away from said floor.

8. The system of claim 4, wherein said first positioning function comprises an upward radial lift function used to move a leg rest of said automobile seat radially downward toward a floor of an automobile chassis, and said second positioning function comprises an upward radial lift function used to move said leg rest radially upward away from said floor.

9. The system of claim 4, further comprising:
at least one motor assembly coupled to said bi-directional deflectable resistor responding to said first control signal and said second control signal, wherein when said first control signal is in said off state said at least one motor assembly is off, wherein when said first control signal is in said on state said at least one motor assembly is on, wherein when said second control signal is in said off state said at least one motor assembly is off, wherein when said second control signal is in said on state said at least one motor assembly is on, and wherein a speed of said at least one motor assembly is controlled by the degree of bending of said bi-directional resistor away from said first configuration.

10. The system of claim 9, further comprising:
a control unit for converting a resistance reading corresponding to said degree of bending of said bi-directional deflectable resistor to a control signal used to vary said speed of said at least one motor assembly.

11. The system of claim 4, further comprising:
a second bi-directional deflectable resistor configured as said bi-directional deflectable resistor for controlling a second pair of controlling functions comprising a third positioning function and a fourth positioning function of said automobile seat, wherein said first and second positioning functions comprise a first pair of controlling functions;
a third control signal used to control said third positioning function, wherein said third control signal is in an off state when said second bi-directional deflectable resistor is positioned in a corresponding first configuration and in an on state when bent away from said corresponding first configuration, wherein an output of said third control signal varies by the degree of bending of said second bi-directional resistor in a corresponding first direction away from said corresponding first configuration; and
a fourth control signal used to control said fourth positioning function, wherein said fourth control signal is in an off state when said second bi-directional deflectable resistor is positioned in a corresponding second configuration and in an on state when bent away from said corresponding second configuration, wherein an output of said fourth control signal varies by the degree of bending of said second bi-directional resistor in a corresponding second direction away from said corresponding first configuration.

12. The system of claim 11, wherein said first, second, third, and fourth positioning functions are taken from a group consisting essentially of:
an inclining function used to incline a backrest of said automobile seat;
a reclining function used to recline said backrest;
a forward function used to move said automobile seat forward on a track, wherein said track positions said automobile seat within a chassis of an automobile;
a backward function used to move said automobile seat backward on said track;
a downward function used to move said automobile seat downward toward a floor of said chassis;
an upward function used to move said automobile seat upward away from said floor;
an upward radial lift function used to move a leg rest of said automobile seat radially downward toward said floor; and
an upward radial lift function used to move said leg rest radially upward away from said floor.
